(19) United States
(12) Patent Application Publication
(10) Pub. No.: US 2024/0080707 A1
(43) Pub. Date: Mar. 7, 2024

(54) METHOD AND SYSTEM FOR BROADCAST AND MULTICAST SERVICES RECEPTION IN 5G

(71) Applicant: SAMSUNG ELECTRONICS CO., LTD., Suwon-si, Gyeonggi-do (KR)

(72) Inventor: Vinay Kumar Shrivastava, Bangalore (IN)

(21) Appl. No.: 18/261,652

(22) PCT Filed: Jan. 14, 2022
(86) PCT No.: PCT/KR2022/000704

§ 371 Date: Jul. 14, 2023

(30) Foreign Application Priority Data
Jan. 15, 2021 (IN) 202141001890
Jan. 4, 2022 (IN) 202141001890

(51) Int. Cl. H04W 28/02; H04L 12/18

(52) U.S. Cl. CPC H04W 28/0268; H04L 12/1886

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. In an embodiment, a method for reception of a service in New Radio (NR) at a User Equipment (UE) is disclosed. The method includes receiving, at the UE, a first message comprising a first configuration from a network, wherein the first configuration enables reception of the service at the UE in an access mode amongst a plurality of access modes. The method includes determining, by the network, a requirement to switch the access mode to another access mode amongst the plurality of access modes for continuing the reception of the service at the UE. The method further includes transmitting, by the network, a second message comprising one or more of the first configuration and at least one other configuration to the UE in response to determining the requirement, wherein the one or more of the first configuration and the at least one other configuration enables reception of the service at the UE in the other access mode. The method further includes receiving, by the UE, the second message from the network, wherein the UE accesses the service in the other access mode through the one or more of the first configuration and the at least one other configuration.

### TECHNICAL FIELD

The present subject matter, in general, relates to wireless communication, in particular, relates to a method and a system for broadcast and multicast services reception in 5G technology.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### DISCLOSURE OF INVENTION

### Technical Problem

Recently, 5G NR is targeting support for Multicast and Broadcast services in its Release 17 version of specification being prepared by 3GPP. In legacy MBMS (Multimedia Broadcast Multicast Services were supported in LTE 4G (Long Term Evolution) wireless systems. However, the architecture and the requirements of 5G Multicast Broadcast Services (MBS) could be very different and there is an effort in the direction of designing the architecture for the network as well as the User Equipment (UE) is in progress.

Specifically, multicast services refer to services being transmitted and availed by a set of UEs registered to a group e.g., Mission Critical Push-To-Talk (MCPTT) service. Broadcast services refer to services being transmitted and available to all the UEs in a specific coverage area where broadcast is performed and typically, UE may not need to be registered. Therefore, effectively, both multicast and broadcast services are PointTo-MultiPoint (PTM) services as there is one transmitter and multiple recipient of contents. It is also possible to provide multicast and broadcast services in a Pointto-Point (PTP) manner, wherein there are multiple PTP connections to share the same MBS services with multiple recipients. Apart from Multicast and Broadcast services, there are another category of services termed as Unicast services which is meant for one recipient only for this is one to one dedicated connection between transmitter and receiver.

It is possible to have PTM bearer, PTP bearer or a combination of PTM and PTP bearer to carry the same MBS service. Combination of PTM and PTP bearer may provide a lot of features with respect to increased reliability of reception of MBS service packets, efficient switching between these two modes of reception when needed e.g., because of mobility, network loading conditions or based on the user request density for the reception of the MBS service and accordingly network may decide the delivery modes and/or switching across. Here, the bearer configuration is referred as the configuration which has possibly both legs of PTM and PTP termed as MBS split bearer.

Thus, the broadcast MBS services and/or low QoS multicast MBS services need to be receivable by Idle/Inactive as well as Connected mode UEs. However, there is no mechanism or solution present in 5G MBS as of present as to how this can be fulfilled. More particularly, which BWPs are utilized, how transitions across Idle/Inactive and

Connected modes are performed, how signaling for configurations is executed and how prioritization for different services can be performed.

Thus, as may be seen, there exists a need to provide a methodology in order to overcome one of the above-mentioned problems.

### Solution to Problem

In accordance with some example embodiments of the present subject matter, a method for reception of a service in New Radio (NR) at a User Equipment (UE) is disclosed. The method includes receiving, at the UE, a first message comprising a first configuration from a network. The first configuration enables reception of the service at the UE in an access mode amongst a plurality of access modes. The method includes determining, by the network, a requirement to switch the access mode to another access mode amongst the plurality of access modes for continuing the reception of the service at the UE. The method further includes transmitting, by the network, a second message comprising one or more of the first configuration and at least one other configuration to the UE in response to determining the requirement. The one or more of the first configuration and the at least one other configuration enables reception of the service at the UE in the other access mode. The method further includes receiving, by the UE, the second message from the network. The UE accesses the service in the other access mode through the one or more of the first configuration and the at least one other configuration.

In accordance with some example embodiments of the present subject matter, a system for reception of a service in New Radio (NR) at a User Equipment (UE) is disclosed. The system includes receiving, at the communication unit, a first message comprising a first configuration from a network. The first configuration enables reception of the service at the UE in an access mode amongst a plurality of access modes. The system includes determining, by the network, a requirement to switch the access mode to another access mode amongst the plurality of access modes for continuing the reception of the service at the UE. The system further includes transmitting, by the network, a second message comprising one or more of the first configuration and at least one other configuration to the UE in response to determining the requirement. The one or more of the first configuration and the at least one other configuration enables reception of the service at the UE in the other access mode. The system further includes receiving, by the communication unit, the second message from the network. The UE accesses the service in the other access mode through the one or more of the first configuration and the at least one other configuration.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### Advantageous Effects of Invention

This summary is provided to introduce a selection of concepts, in a simplified format, that are further described in the detailed description of the invention. This summary is neither intended to identify key or essential inventive concepts of the invention and nor is it intended for determining the scope of the invention.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an environment comprising a UE communicating with a network for reception of a service in New Radio (NR) at a User Equipment (UE), in accordance with an embodiment of the present subject matter;

FIG. 2a illustrates an operational flow diagram depicting a process for reception of a multicast service at the UE, in accordance with an embodiment of the present subject matter;

FIG. 2b illustrates an operational flow diagram depicting a process for terminating the reception of the multicast service at the UE, in accordance with an embodiment of the present subject matter

FIG. 2c illustrates an operational flow diagram depicting a process for modifying a configuration associated with the multicast service, in accordance with an embodiment of the present subject matter;

FIG. 3a illustrates an operational flow diagram depicting a process for reception of a multicast service or a broadcast service at the UE, in accordance with an embodiment of the present subject matter;

FIG. 3b illustrates an operational flow diagram depicting a process for switching the UE from a second access mode to a first access mode for receiving the multicast service or the broadcast service at a UE, in accordance with an embodiment of the present subject matter;

FIG. 4 illustrate an operational flow diagram depicting a process for determining a congestion at the network, in accordance with an embodiment of the present subject matter;

FIG. 5 illustrates an operational flow diagram depicting an access mode switching, in accordance with an embodiment, of the present subject matter;

FIG. 6 illustrates an operational flow diagram depicting a process for a Bandwidth Part (BWP) operation for receiving a service at the UE, in accordance with an embodiment of the present subject matter;

FIG. 7 is a diagram illustrating the configuration of a terminal in a wireless communication system according to an embodiment of the present subject matter; and

FIG. 8 illustrates a schematic block diagram 800 depicting a method for reception of a service in NR at a UE, in accordance with an embodiment of the present subject matter

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### MODE FOR THE INVENTION

For promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

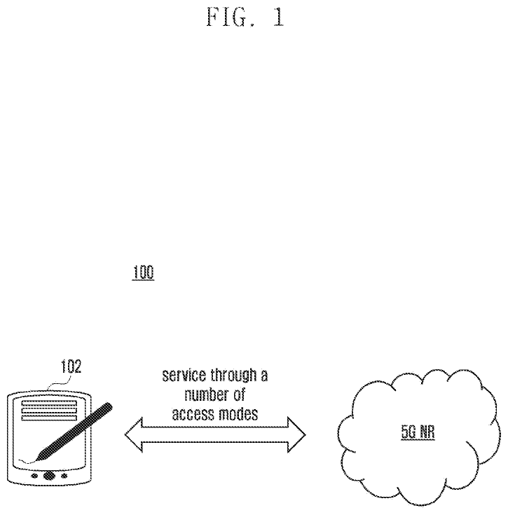

FIG. 1 illustrates an environment 100 comprising a UE 102 communicating with a network for reception of a service in New Radio (NR) at a User Equipment (UE), in accordance with an embodiment of the present subject matter. In an embodiment, the service may be one of a broadcast service and a multicast service. In an embodiment, the service may be received at the UE 102 in a number of access modes.

Continuing with the above embodiment, the UE 102 may be configured to receive a first message. In an embodiment, the first message may include a first configuration from the network. In an embodiment, the first configuration may be configured to enables reception of the service at the UE 102 in an access mode amongst the number of access modes. In an embodiment, the first configuration may be one of a RRC configuration, a System Information Block (SIB) configuration and a Multicast Control Channel (MCCH) configuration. Further, first message may be the RRC reconfiguration message for the multicast service and the first message may be the SIB message or MCCH message for the broadcast service. Subsequent to transmitting the first message and enabling the reception of the service at the UE, the network may be configured to determine a requirement to switch the access mode to another access mode amongst the number of access modes for continuing the reception of the service at the UE 102. In an embodiment, the requirement to switch the access mode to the other access mode may be determined in response to detecting occurrence of an event associated with the access mode. Subsequently, the event may be one of a congestion at the network, a change in a Quality of Service (QoS) associated with the service, a presence of a new service to be provided to the UE 102 in a connected mode.

In response to determining the requirement to switch the access mode with the other access mode, the network may be configured to transmit a second message to the UE 102. In an embodiment, the second message may include one or more of the first configuration and at least one other configuration. In an embodiment, the one or more of the first configuration and the at least one other configuration may be configured to enable the reception of the service at the UE 102 in the other access mode. In an embodiment, the at least one other configuration may be one of a RRC release configuration and a RRC release with suspend configuration, a RRC connection establishment configuration, and a RRC connection resumption configuration.

Continuing with the above embodiment, the UE 102 may be configured to receive the second message from the network. In an embodiment, the UE 102 may be configured to access the service in the other access mode through the one or more of the first configuration and the at least one other configuration.

In an embodiment, the UE 102 may switch the service reception from the access mode to the other access mode. For this purpose, the UE 102 may check an availability of the service through other access mode in a broadcasted signalling information (e.g. SIB or MCCH or paging message) or alternatively, the UE 012 may inform the network about a need of the service delivery in other access mode such as through a MBS interest indication message, a UE assistance information message, or the like. Further, there may be a number of approaches to perform the access mode to other access mode transition listed as:

In an embodiment, the network switches the service for the UE 102 from the access mode to the other access mode i.e. the network terminates the access mode delivery of the service for the UE 102. The network provides the RRC reconfiguration message for the same with releasing or removing the dedicated configuration used for the access mode and/or the network provides an access mode switch command to the UE 102 using one of a MAC, and a RRC signalling.

The network releases the RRC connection for the UE 102 receiving the service through the access mode and allows the UE 102 therefore to continue receiving the service in the other access mode in Idle and/or Inactive mode. This may be in response to a UE's request or a UE assistance information message that may also include a UE's preferred state such as Idle mode or Inactive mode.

The UE 102 terminates the service reception in access mode and avails the service through the other access mode when it is available on the active BWP or initial BWP which is accessible to UE 102. The UE 102 releases the RRC connection when a dataInactivitytimer expires and starts receiving the desired service in the other access mode through the initial BWP or MBS BWP.

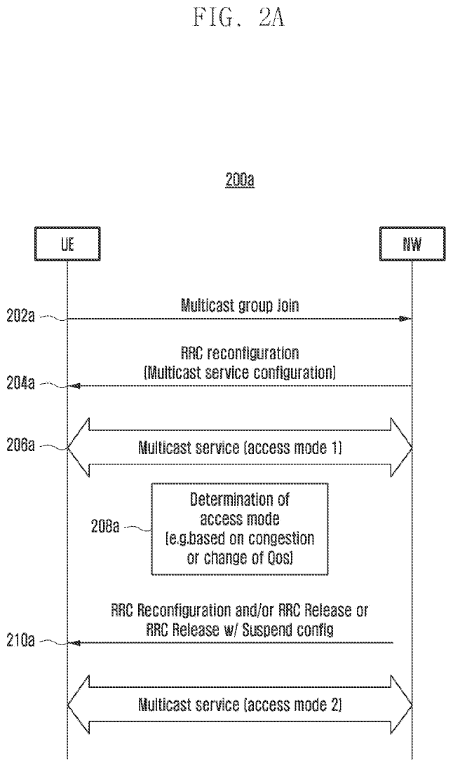

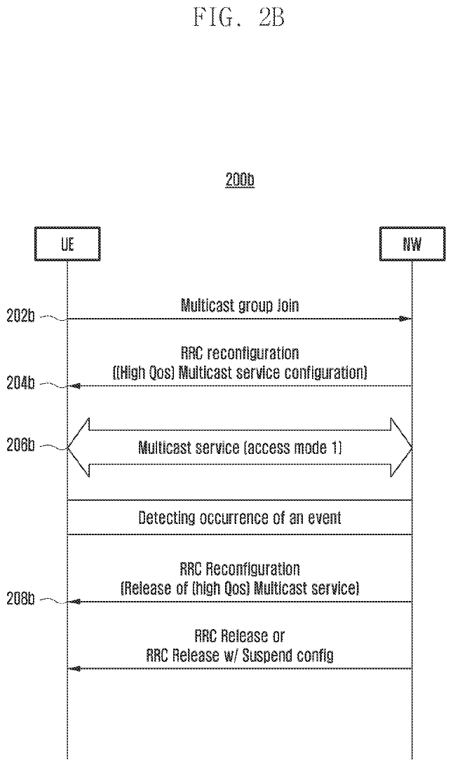

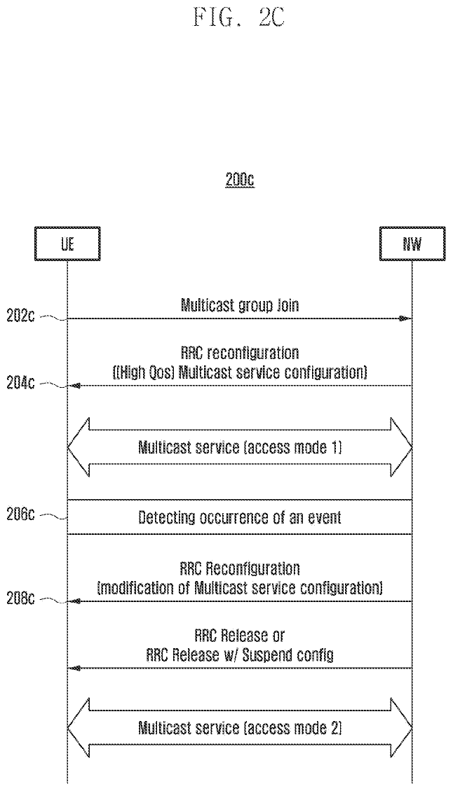

FIG. 2a illustrates an operational flow diagram 200 depicting a process for reception of a multicast service at the UE, in accordance with an embodiment of the present subject matter. In an embodiment, the multicast service may be received by the UE from a network. In an embodiment, the network may be a 5G network. In an embodiment, the UE may be the UE 102 as referred in the FIG. 1. In an embodiment, the multicast service may be one of a low QoS multicast service and a high QoS multicast service.

In an embodiment, the multicast service may be received through a number of access modes. In an embodiment, the number of access modes may include an access mode referred as a first access mode and another access mode referred as a second access mode. In an embodiment, the first access mode may be a Connected mode and the second access mode may be one of an Idle mode and an Inactive mode. In an embodiment, for establishing a connection for one or more of the high QoS multicast service, critical multicast services over the first access mode, the UE 102 may be configured to utilize a higher access category such as an access category 0.

In an embodiment, the critical multicast services may be provided in the second access mode with a low (reduced) QoS when there is congestion for the network. In the above embodiment, a configuration for the multicast service and the broadcast service may be provided with a broadcast signalling only as a separate instance of a same service in the second access mode, that is, a configuration for the same multicast service and the broadcast service may be provided with a dedicated signaling for first access mode. The configurations for second access mode and the first access mode for the same multicast service and the broadcast service may differ for parameters related to a BWP or a CFR used or a reliability support such as one of a HARQ retransmission, a HARQ feedback support, a CSI feedback support, and a MIMO antennae techniques support. Continuing with the above embodiment, the process may include transmitting (step 202a) a multicast join request by the UE 102 to the network. In an embodiment, the multicast join request transmitted by the UE 102 may indicate that the UE 102 is trying to receive the multicast service through the number of access modes.

In response to transmitting the multicast join request, the process may include transmitting (step 204a) a first message from the network to the UE 102 upon receiving the multicast join request by the network. In an embodiment, the first message may include a first configuration enabling reception of the multicast service at the UE 102. In an embodiment, the first configuration may be a RRC configuration. In an embodiment, upon receiving the first configuration, the UE 102 may initiate receiving the service through the first access mode (step 206a).

In an embodiment, the process may further include determining (step 208a) a requirement to switch the first access mode to the second access mode amongst the number of access modes for continuing the reception of the service at the UE 102. In an embodiment, the requirement to switch the amongst the number of access modes may be determined by the network in response to detecting occurrence of an event. Examples of the occurrences may include, but are not limited, to a congestion at the network, a change in a reported signal strength measurement associated with the UE, and a change in a QoS associated with the multicast service. In an embodiment, the change may indicate changing of the high QoS multicast service with the low QoS multicast service.

Continuing with the above embodiment, the process may include transmitting (step 210a) by the network, a second message to the UE 102. In an embodiment, the second message may include one or more of the first configuration and at least one other configuration in response to determining the requirement. In an embodiment, the one or more of the first configuration and the at least one other configuration may be configured to enable the reception of the multicast service at the UE 102 in the second access mode. In an embodiment, the at least one other configuration may be one of a RRC release configuration and a RRC release with suspend configuration. In an embodiment, the RRC release configuration may be configured to release the UE 102 from the first access mode and enable the reception of the multicast service through the second access mode in an Idle mode. Furthermore, the RRC release with suspend configuration may be configured to release the UE 102 from the first access mode and enable the reception of the multicast service through the second access mode in an Inactive mode.

Subsequently, the process may include receiving (step 210a) at the UE 102, the second message from the network. In an embodiment, the UE 102 may be configured to access the service in the second access mode through the one or more of the first configuration and the at least one other configuration upon receiving the second message. In an embodiment, the multicast service may be accessed through the second access mode over one of an initial Bandwidth Part (BWP), the initial BWP along with a dedicated BWP, a default BWP, and a specific service BWP or a Common Frequency Resource (CFR). In an embodiment, the initial BWP may include an allocation for a multicast service BWP or the CFR for the UE 102 receiving the multicast service through one of the first access mode and the second access mode. In an embodiment, the service allocation may overlap with another allocation associated with a dedicated unicast BWP or the CFR for the multicast service to support the UE 102 receiving one of a broadcast service and the multicast service (e.g. low QoS multicast service) through the first access mode. In an alternative embodiment, where an absence of the overlapping between the initial BWP and a unicast active BWP of the UE 102 receiving the multicast service through the first access mode is determined, a connected mode UE such as the UE 102 in the first access mode may be configured to avail one or more of a broadcast service and the multicast service over the initial BWP along with a unicast service when an active/dedicated BWP of the UE 102 is switched to the initial BWP. Further, the connected mode UE may not be configured to avail the one or more of the broadcast service and the multicast service and/or continue with the unicast services if any, over the active/dedicated BWP.

In an embodiment, the multicast service allocation (the BWP or the CFR) may be different for the initial BWP and the dedicated BWP. In an embodiment, the UE 102 capable of a dual carrier or a dual RX may receive one or more of a broadcast service and the multicast service such as a low QoS multicast service) through the first access mode over one of the dedicated BWP and the initial BWP, depending on whether their unicast active BWP matches or not with the multicast dedicated BWP.

In an embodiment, where the UE 102 is not capable of the dual carrier or the dual RX, the UE 102 may receive one or more of a broadcast service and the multicast service in the first access mode over the dedicated BWP if it matches with their unicast active BWP. In an embodiment, where the UE 102 is not capable of the dual carrier or the dual RX, the UE 102 may receive one or more of a broadcast service and the multicast service through the first access mode over the initial BWP if the multicast service dedicated BWP is not matching with the unicast active BWP and the UE 102 may further terminate the unicast service such that the UE 102 switches or is switched by network to the initial BWP to receive the multicast service. Alternatively, the UE 102 may pursue the unicast service on the unicast active BWP and may not undertake the multicast reception. In an embodiment, over the default BWP configured for the multicast service reception, the connected mode UE may be switched to the default BWP by the network or upon an expiration of a bwp-Inactivitytimer. Alternatively, the UE 102 may terminate the unicast service in an embodiment, where the unicast service is present and may further switch to the default BWP configured for multicast service. Furthermore, in an embodiment, where the service is accessed through the second access mode over the specific multicast BWP or the CFR, the multicast BWP or the CFR may be accessible to the UE 102 in in any of the first access mode and the second access mode. The MBS BWP or the CFR may be on the initial BWP or may be extended over the initial BWP or may be a separate MBS BWP or the CFR.

In an embodiment, where it is determined that the UE 102 is receiving the multicast service through the second access mode over the specific service BWP or the CFR including a scenario when the multicast service BWP or the CFR may be confined within the initial BWP or may be mapped over the initial BWP and/or an extended over BWP or the CFR that comprises the initial BWP within itself, the process may further include switching the UE 102 from the specific service BWP or the CFR to the initial BWP based one of abandoning by the UE 102 the reception of the service and changing by the one of a cell and an area providing the multicast service. In an embodiment, the process may further include establishing by the UE 102 a RRC connection and receiving the multicast service in a PTP (Point to point) delivery mode or a unicast mode on the dedicated BWP in response to determining that the multicast service is abandoned by the network.

In an embodiment, the UE receives the configuration information for the switching across the multicast service BWP or the CFR and the initial BWP through one of the SIB, MCCH RRC signaling and PDCCH signaling carrying the Time Domain Resource Allocation (TDRA) and Frequency Domain Resource Allocation (FDRA) information. The multicast service BWP or the CFR may be configured as larger than the initial BWP. Based on the signaling, UE transits across the multicast service BWP or the CFR and the initial BWP.

FIG. 2b illustrates an operational flow diagram 200b depicting a process for terminating the reception of the multicast service at the UE 102, in accordance with an embodiment of the present subject matter. In an embodiment, the process may include performing steps 202b and 204b similar to steps 202a and 204a as performed in the FIG. 2a.

Continuing with the above embodiment, the process may include determining (step 206b) occurrence of an event at the network. In an embodiment, the event may be a congestion status at network, a change in a QoS associated with the multicast service. In an embodiment, the change in the QoS may indicate that the high QoS multicast service is replaced at the network by the low QoS multicast service.

Continuing with the above embodiment, the process may include transmitting (step 208b) by the network, the second message to the UE 102. In an embodiment, the second message may include one or more of the first configuration and the at least one other configuration. In an embodiment, one or more of the first configuration can be RRC reconfiguration carrying a release of the multicast service configuration. In an embodiment, the at least one other configuration may be one of the RRC release configuration and the RRC release with suspend configuration. In an embodiment, the RRC release configuration may be configured to release the UE 102 to an Idle mode. Furthermore, the RRC release with suspend configuration may be configured to release the UE 102 to an Inactive mode.

FIG. 2c illustrates an operational flow diagram 200c depicting a process for modifying a configuration associated with the multicast service, in accordance with an embodiment of the present subject matter. In an embodiment, modifying the configuration may include changing the high QoS multicast service to the low QoS multicast service. In an embodiment, the process may include performing steps 202c and 204c similar to steps 202a and 204a as performed in the FIG. 2a.

Continuing with the above embodiment, the process may include determining (step 206c) occurrence of an event at the network. In an embodiment, the event may be a congestion status at network, a change in a QoS associated with the multicast service. In an embodiment, the change in the QoS may indicate that the high QoS multicast service is replaced at the network by the low QoS multicast service.

Continuing with the above embodiment, the process may include transmitting (step 208c) by the network, the second message to the UE 102. In an embodiment, the second message may include the one or more of the first configuration and the at least one other configuration. In an embodiment, the at least one other configuration may be one of the RRC release configuration and the RRC release with suspend configuration for modifying the configuration of the multicast service. In an embodiment, the RRC release configuration may be configured to release the UE 102 from the first access mode and enable the reception of the multicast service through the second access mode in the Idle mode. Furthermore, the RRC release with suspend configuration may be configured to release the UE 102 from the first access mode and enable the reception of the multicast service through the second access mode in the Inactive mode.

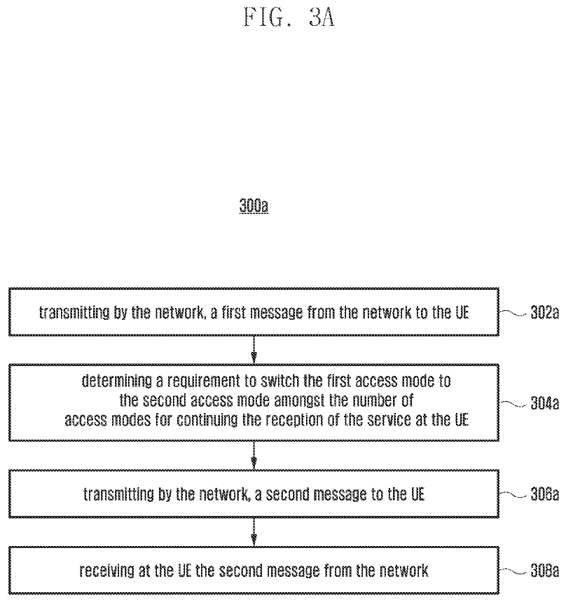

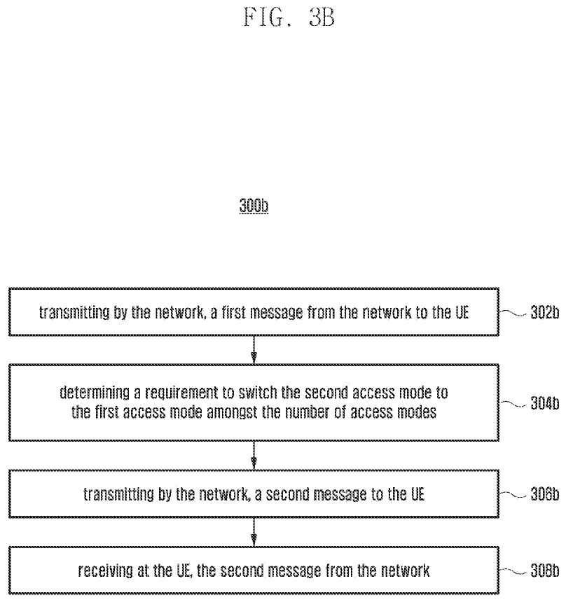

FIG. 3a illustrates an operational flow diagram 300a depicting a process for reception of a multicast service or a broadcast service at the UE, in accordance with an embodiment of the present subject matter. In an embodiment, the broadcast service may be received by the UE 102 from a network. In an embodiment, the network may be a 5G network. In an embodiment, the UE 102 may be the UE 102 as referred in the FIG. 1. In an embodiment, the broadcast service may be received through a number of access modes. In an embodiment, the number of access modes may include an access mode referred as a first access mode and another access mode referred as a second access mode. In an embodiment, the first access mode may be a Connected mode and the second access mode may be one of the Idle mode and the Inactive mode.

In an embodiment, the broadcast services and the multicast service such as a low QoS multicast service may be provided in the Idle mode and the Inactive mode for the UE 102 such that a coverage of the service is across a number of devices and a dedicated connection is not needed to be maintained. This may be termed as a second access mode amongst a number of access modes. A first access mode amongst the number of access modes refers to a high QoS multicast service delivery to connected mode UE 102. In an embodiment, where the UE 102 is connected, there is no need for the UE 102 to receive a dedicated configuration for the broadcast service and/or the low QoS multicast service. However, when the low QoS multicast service is availed, the UE may need to join a multicast group at least once. With the low QoS multicast service, multicast services with no stringent reliability requirements are implied and therefore, may not need HARQ retransmissions and/or ARQ retransmissions and/or HARQ feedback. In an exemplary embodiment, it may be possible to receive repeated transmissions or the HARQ retransmission without explicitly providing the HARQ feedback, if the retransmissions or repetitions are provided.

In an embodiment, a USD based information may be useful for the UE 102 as the broadcast services may be expected to be remain unchanging. For the UE 102 in second access mode, the USD/service announcement may be mapped to some MTCH and may need to be refreshed at a frequency (to support newly joining UE 102 inbetween as well). Similarly, a NR MBS MCCH may possibly include longer modification periods (e.g. 5 or 10 sec) with shorter repetition periods to help UE 102 joining in between and reducing setup times associated with the UE 102.

In an embodiment, the UE 102 may not be required to read the MCCH (broadcasted PTM configuration) at each modification boundary. The UE 102 may receive a PTM configuration change indication through PDCCH DCI bits, paging, short message, and a SIB and when there is a change is notified to the UE, the UE 102 may undertake reading of the MCCH message at the beginning of a next modification boundary or an earliest MCCH transmission. In an embodiment, a change indication and the MCCH message may be provided in a same sub-frame, and the UE 102 may undertake reading of the MCCH message only when the change indication is present such as an indicating change of MCCH message.

Continuing with the above embodiment, the process may include transmitting (step 302a) by the network, a first message from the network to the UE 102 for providing the broadcast service. In an embodiment, the first message may include a first configuration enabling reception of the broadcast service at the UE 102. In an embodiment, the first configuration may be a System Information Block (SIB) or a Multicast Control Channel (MCCH) configuration. In an embodiment, upon receiving the first configuration, the UE 102 may initiate receiving the broadcast service through the first access mode by default.

In an embodiment, the process may further include determining (step 304a) a requirement to switch the first access mode to the second access mode amongst the number of access modes for continuing the reception of the service at the UE 102. In an embodiment, the requirement to switch the amongst the number of access modes may be determined by the network in response to detecting occurrence of an event. Examples of the occurrences may include, but are not limited, to a congestion at the network, and a presence of a new service to be provided to the UE 102 in aa connected mode.

Continuing with the above embodiment, the process may include transmitting (step 306a) by the network, a second message to the UE 102. In an embodiment, the second message may include at least one other configuration in response to determining the requirement. In an embodiment, the at least one other configuration may be configured to enable the reception of the broadcast service at the UE 102 in the second access mode. In an embodiment, the at least one other configuration may be one of a RRC release configuration and a RRC release with suspend configuration. In an embodiment, the RRC release configuration may be configured to release the UE 102 from the first access mode and enable the reception of the broadcast service through the second access mode in an Idle mode. Furthermore, the RRC release with suspend configuration may be configured to release the UE 102 from the first access mode and enable the reception of the multicast service through the second access mode in an Inactive mode.

Subsequently, the process may include receiving (step 308a) at the UE 102, the second message from the network. In an embodiment, the UE 102 may be configured to access the multicast service or the broadcast service in the second access mode through the at least one other configuration upon receiving the second message. In an embodiment, the broadcast service may be accessed through the second access mode over one of an initial Bandwidth Part (BWP), the initial BWP along with a dedicated BWP, a default BWP, and a specific service BWP or a Common Frequency Resource (CFR). In an embodiment, the initial BWP may include an allocation for a broadcast service BWP or the CFR for the UE 102 receiving the broadcast service through one of the first access mode and the second access mode. In an embodiment, the service allocation may overlap with another allocation associated with a dedicated unicast BWP or the CFR for the broadcast service to support the UE 102 receiving one of a broadcast service and the low QoS broadcast service through the first access mode. In an alternative embodiment, where an absence of the overlapping between the initial BWP and a unicast active BWP of the UE 102 receiving the broadcast service through the first access mode is determined, a connected mode UE such as the UE 102 in a first access mode 102 may be configured to avail one or more of a broadcast service and the low QoS broadcast service over the initial BWP along with a unicast service when an active/dedicated BWP of the UE 102 is switched to the initial BWP. Further, the connected mode UE may not be configured to avail the one or more of the broadcast service and the low QoS broadcast service and/or continue with the unicast services if any, over the active/dedicated BWP.

In an embodiment, the broadcast service allocation (the BWP or the CFR) may be different for the initial BWP and the dedicated BWP. In an embodiment, the UE 102 capable of a dual carrier or a dual RX may receive one or more of a broadcast service and the low QoS broadcast service through the first access mode over one of the dedicated BWP and the initial BWP, depending on whether their unicast active BWP matches or not with the broadcast dedicated BWP.

In an embodiment, where the UE 102 is not capable of the dual carrier or the dual RX, the UE 102 may receive one or more of a broadcast service and the low QoS broadcast service in the first access mode over the dedicated BWP if it matches with their unicast active BWP. In an embodiment, where the UE 102 is not capable of the dual carrier or the dual RX, the UE 102 may receive one or more of a broadcast service and the low QoS broadcast service through the first access mode over the initial BWP if the broadcast service dedicated BWP is not matching with the unicast active BWP and the UE 102 may further terminate the unicast service such that the UE 102 switches or is switched by network to the initial BWP to receive the broadcast service. Alternatively, the UE 102 may pursue the unicast service on the unicast active BWP and may not undertake the broadcast reception. In an embodiment, over the default BWP configured for the broadcast service reception, the connected mode UE may be switched to the default BWP by the network or upon an expiration of a bwp-Inactivitytimer. Alternatively, the UE 102 may terminate the unicast service in an embodiment, where the unicast service is present and may further switch to the default BWP configured for broadcast service. Furthermore, in an embodiment, where the service is accessed through the second access mode over the specific broadcast BWP or the CFR, the broadcast BWP or the CFR may be accessible to the UE 102 in in any of the first access mod and the second access mode. The MBS BWP or the CFR may be on the initial BWP or may be extended over the initial BWP or may be a separate MBS BWP or the CFR.

In an embodiment, where it is determined that the UE 102 is receiving the broadcast service through the second access mode over the specific service BWP or the CFR including a scenario when the broadcast service BWP or the CFR may be confined within the initial BWP or may be mapped over the initial BWP and/or an extended over BWP or the CFR that comprises the initial BWP within itself, the process may further include switching the UE 102 from the specific service BWP or the CFR to the initial BWP based one of abandoning by the UE 102 the reception of the service and changing by the one of a cell and an area providing the broadcast service. In an embodiment, the process may further include establishing by the UE 102 a RRC connection and receiving the broadcast service in a PTP (Point to point) delivery mode or a unicast mode on the dedicated BWP in response to determining that the broadcast service is abandoned by the network.

In an embodiment, UE receives the configuration information for the switching across the broadcast service BWP or the CFR and the initial BWP through one of the SIB, MCCH RRC signaling and PDCCH signaling carrying the Time Domain Resource Allocation (TDRA) and Frequency Domain Resource Allocation (FDRA) information. The broadcast service BWP or the CFR may be configured as larger than the initial BWP. Based on the signaling, UE transits across the broadcast service BWP or the CFR and the initial BWP.

FIG. 3b illustrates an operational flow diagram 300b depicting a process for switching the UE 102 from a second access mode to a first access mode for receiving the multicast service or the broadcast service at a UE 102, in accordance with an embodiment of the present subject matter.

Continuing with the above embodiment, the process may include transmitting (step 302b) by the network, the first message from the network to the UE 102 for providing the broadcast service. In an embodiment, upon receiving the first configuration, the UE 102 may initiate receiving the broadcast service through the second access mode by default.

In an embodiment, the process may further include determining (step 304b) the requirement to switch the second access mode to first second access mode for continuing the reception of the service at the UE 102. In an embodiment, the requirement may be determined by the network in response to detecting occurrence of the event.

Continuing with the above embodiment, the process may include transmitting (step 306b) by the network, the second message to the UE 102. In an embodiment, the second message may include at least one other configuration in response to determining the requirement. In an embodiment, the at least one other configuration may be configured to enable the reception of the broadcast service at the UE 102 in the first access mode. In an embodiment, the at least one other configuration may be one of a RRC connection establishment configuration, and a RRC connection resumption configuration to switch the reception of the multicast service or the broadcast service at the UE 102 through the second access mode to the first access mode.

Subsequently, the process may include receiving (step 308b) at the UE 102, the second message from the network. In an embodiment, the UE 102 may be configured to access the multicast service or the broadcast service in the first access mode through the at least one other configuration upon receiving the second message. The second message may comprise one of the RRC connection establishment message, and the RRC connection resumption message to switch the reception of one of the multicast service and the broadcast service at the UE through the second access mode to the first access mode

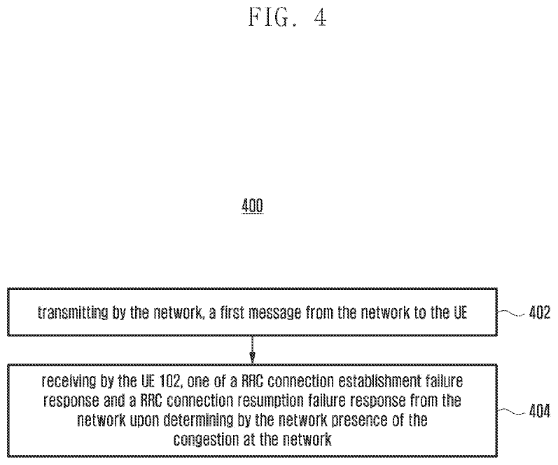

FIG. 4 illustrate an operational flow diagram 400 depicting a process for determining a congestion at the network, in accordance with an embodiment of the present subject matter. In an embodiment, the network may be providing a service to the UE 102 through a number of access modes. In an embodiment, the service may be one of a broadcast service and a multicast service. In an embodiment, the number of access modes may include a first access mode and a second access mode. In an exemplary embodiment, the UE 102 may be receiving the service through the second access mode.

In an embodiment, an admission control may not allow the UE 102 to enter a connected mode or join the multicast service due to an overload or the network load may be high or a specific multicast service, or a broadcast service is being availed by many connected mode UE such as the UE 102 in a first access mode causing a limitation on a support in terms of signaling, a control channel, measurement operations, feedback and/or retransmissions. Additionally, the network may also provision for Idle/Inactive mode UE 102 to receive some critical or public safety services in the Idle/Inactive mode itself in order to reduce a power consumption and/or increase a service or device coverage or to further facilitate a receive only mode for the multicast service. In an embodiment, the second access mode may be used as:
a. Idle/Inactive mode UE 102 may receive a low QoS multicast service such that reliability aspects related to a Hybrid automatic repeat request (HARQ) feedback, one or more of HARQ retransmissions, a CSI (Channel state Indicator) feedback, a use of MIMO (Multiple Input Multiple inputs) antennae techniques may not be supported.
b. Connected mode UE may be pushed/switched to the Idle/Inactive mode to start/continue receiving the low QoS multicast service.
c. Connected mode UE may be pushed/switched to start/continue receiving the low QoS multicast service connected mode with the second access mode.

Continuing with the above embodiment, the process may include transmitting (step 402), by the UE 102, one of a RRC connection establishment request and a RRC connection resumption request to the network. In an embodiment, the one of a RRC connection establishment request and a RRC connection resumption request may be transmitted for switching to the first access mode from the second access mode for receiving the service.

In an embodiment, the process may further include receiving (step 404) by the UE 102, one of a RRC connection establishment failure response and a RRC connection resumption failure response from the network upon determining by the network presence of the congestion at the network.

In an embodiment, the network may inform the UE 102 about a congestion status for the multicast service and the broadcast service and therefore, may guide the UE 102 to transit from the second access mode to the first access mode when there is no congestion indicated. Alternatively, in an embodiment, when the congestion is indicated, the UE 102 may pursue the reception in second access mode. The indication may be broadcasted (e.g. SIB/MCCH/USD/Service announcement or as MBS service configuration parameter) and/or informed to the UE 102 in an embedded signaling (i.e. along with the MBS control or traffic contents). Alternatively, when a RACH procedure fails or Overload or Back-off indication is provided in a Random Access Response (RAR), the congestion may be determined by the UE 102. Alternatively, the access is barred for a cell or access barring is specified for one or more of the broadcast service, the low QoS multicast service, each MBS service. Accordingly, the UE 102 may attempt the access for the specific MBS service.

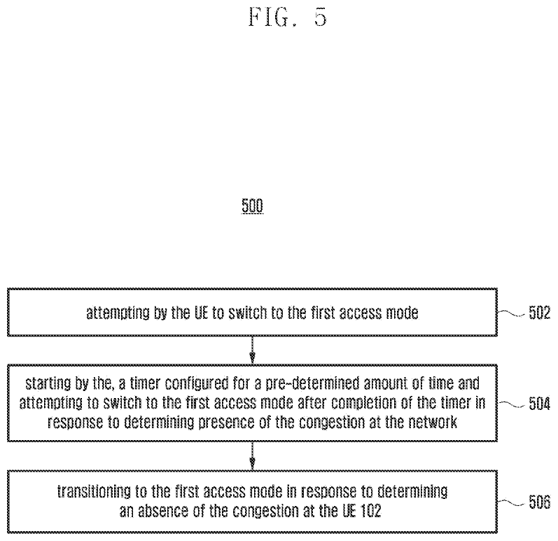

FIG. 5 illustrates an operational flow diagram 500 depicting an access mode switching, in accordance with an embodiment, of the present subject matter. In an embodiment, the access mode switching may be performed when the UE 102 is receiving low QoS multicast service through a second access mode amongst a number of access modes.

Subsequently, the process may include attempting (step 502) by the UE 102 to switch to the first access mode. In an embodiment, the switching may be attempted by sending one of a RRC connection establishment request and a RRC connection resumption request to the network to switch to the first access mode. In an embodiment, the UE 102 may be configured to determine presence of the congestion at the network. In an embodiment, the UE 102 may be configured to determine whether the congestion is present or not at the network based on receiving an indication from the network. In an embodiment, the indication may determine whether the congestion is occurring at the network or not upon sending one of the RRC connection establishment request and the RRC connection resumption request. Further, the process may include proceeding towards one of a step 504 and step 506.

Moving forward, the process may include starting (step 504) by the UE 102, a timer configured for a pre-determined amount of time and attempting to switch to the first access mode after completion of the timer in response to determining presence of the congestion at the network. In an embodiment, the indication depicting presence of the congestion may be broadcasted (SIB/MCCH/USD/Service announcement or as multicast service configuration parameter, and a broadcast service configuration parameter). In an embodiment, the indication may be informed to the UE 102 in an embedded signaling (along with a MBS control or traffic contents). Alternatively, in an embodiment, where a RACH procedure fails or overloads or a back-off indication is provided in a Message 2/Random Access Response (RAR), the congestion is determined by UE 102. Alternatively, an access is barred for a cell or an access barring is specified for one or more of the broadcast, a low QoS MBS service, and for each MBS service. Accordingly, the UE 102 may attempt an access for the specific MBS service.

In an embodiment, the determination may be generated based on receiving from the network one of a RRC connection establishment failure response and a RRC connection resumption failure response in response to transmitting the one of a RRC connection establishment request and a RRC connection resumption request.

Further, the process may include transitioning (step 506) to the first access mode in response to determining an absence of the congestion at the UE 102.

The UE 102 may be in the second access mode when the high QoS multicast service is starting or the high QoS multicast service is started. The UE 102 needs to transit to the first access mode to pursue the service reception of a high QoS multicast service in order to ensure reliability aspects are fulfilled. To that understanding, a broadcast signaling such as a SIB/MCCH/Service Announcement and a User Service Description (USD) such as an Electronic Program Guide (EPG) indicates at least one of TMGIs information of the multicast Service, applicable delivery mode(s) of the multicast service, a BWP or a CFR such as one of an Initial BWP, a MBS BWP, and a dedicated BWP, congestion status. Further, rest of configuration information may be provided through a dedicated signaling and the UE 102 needs to avail same in the first access mode. The UE 102 may report the TMGI in an interested indication message to the network and network may configure the UE 102 to the relevant dedicated BWP for a reception of the multicast service in first access mode. For this, the UE 102 may perform a random access procedure and get into a RRC connection state and may further initiate an MBS interest indication message and receive a MBS service configuration through a dedicated signaling. The UE 102 may also trigger multicast group joining or re-joining procedure.

In another embodiment of the present disclosure, Interest Indication for the second access mode is supported for the UEs receiving MBS service in the connected mode. the UE 102 utilizes the common MBS interest indication message used for the first access mode or the high QoS multicast services also to indicate for the second access mode or the low QoS multicast services or broadcast services, the UE 102 may indicate in the interest indication message the MBS BWP or frequency resource, TMGIs, priority for the broadcast, preferred delivery mode, frequency information, the UE 102 capability information e.g., support for carrier aggregation, supported band or band combination, dual RX/TX support, bandwidth or BWPs supported/configured/activated, and need to switch to initial BWP or default BWP or MBS BWP etc. Based on MBS interest indication message, network can switch the active BWP to initial or default or MBS BWP such as when the UE 102 is switched to initial BWP by network, the UE 102 can continue receiving MBS as well as unicast services or when the UE 102 is switched to dedicated BWP by network which also supports MBS service, the UE 102 can continue receiving MBS as well as unicast services.

The UE 102 may prioritize certain low QoS multicast MBS service(s) and/or broadcast MBS service(s) being received/available in the second access mode over certain unicast service(s) and the UE 102 continues to remain in the second access mode with MBS service reception in second access mode or switches to receive MBS service in Idle/Inactive mode with the second access mode.

The UE 102 is in a connected mode and receiving unicast and MBS service in the second access mode. The UE 102 continues to receive MBS service in The second access mode in Connected mode. The UE 102 is in connected mode and receiving MBS service in the second access mode. Further, there may be a number of alternatives such as the UE 102 continues to receive MBS service in The second access mode in Connected mode, the UE 102 falls to Idle or Inactive mode and continues MBS service in The second access mode, the UE 102 falls to Idle or Inactive mode only after Data-Inactivity Timer expiry and continues MBS service in the second access mode, the UE 102 falls to Idle after receiving RRC Release from network and continues MBS service in the second access mode, the UE 102 falls to Inactive mode after receiving RRC Release with suspend configuration from network and continues MBS service in the second access mode. The UE 102 is in Idle/Inactive mode and receiving MBS service in the second access mode and receives connection establishment request for unicast service. Further, there may be a number of alternatives such as the UE 102 pursues connection establishment for unicast service and when possible, continues to receive MBS service in The second access mode in Connected mode, the UE 102 may not pursue connection establishment for unicast service when unicast service is lower priority or MBS service cannot be pursued in connected mode due to BWP/capability/RX-TX support/service unavailability reasons and continues to receive MBS service in The second access mode in Idle/Inactive mode, the UE 102 pursues connection establishment for unicast service and when possible, switches to receive MBS service in the first access mode, when it can avail service with high QoS and it is available as the first access mode on connected mode active BWP and/or it is not available in the second access mode on connected mode active BWP.

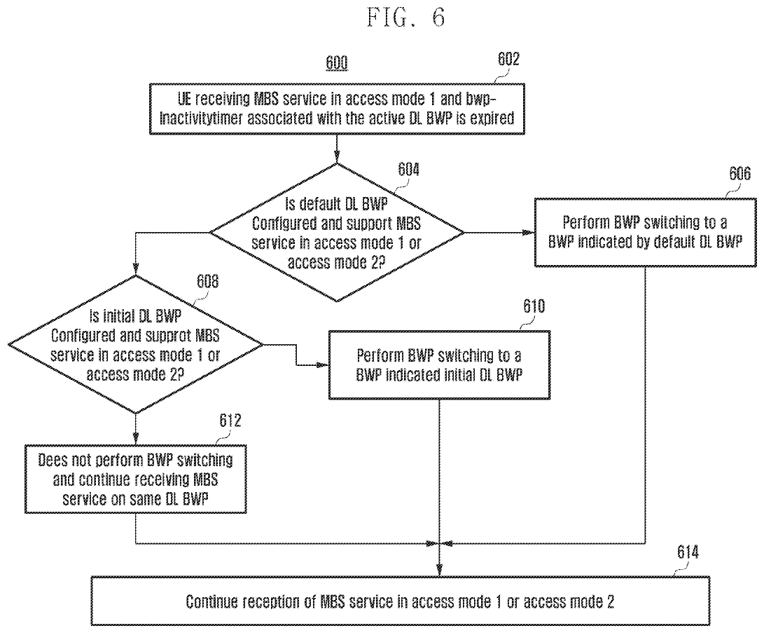

FIG. 6 illustrates an operational flow diagram 600 depicting a process for a Bandwidth Part (BWP) operation for receiving a service at the UE 102, in accordance with an embodiment of the present subject matter. In an embodiment, the service may be one of a multicast service and a broadcast service. Further, the service may be received through a number of access modes. In an embodiment, the number of access modes may include a first access mode and a second access mode.

Continuing with the above embodiment, at step 602, the process may include detecting an expiry of a bwp-inactivitytimer associated with an active Down Link BWP (DL BWP). In an embodiment, the UE 102 may be receiving the service through the first access mode.

Furthermore, at step 604 the process may include determining by the UE 102 whether a default DL BWP is configured and supports the service received through the number of access modes in response to expiration of the bwp-inactivitytimer associated with the DL BWP in an active state.

Moving forward, the process may proceed towards step 606 in response to determining that the default DL BWP is configured and supports the service received through the number of access modes. Furthermore, the process may proceed towards step 608 in response to determining that the default DL BWP is not configured and the default DL BWP is not supporting the service received through the number of access modes.

Continuing with the above embodiment, the at step 606, the process may include switching from the DL BWP to another BWP indicated by the default DL BWP. In an embodiment, the switching may be performed by the UE 102. Furthermore, the process may proceed towards step 614.

Moving forward, at step 608, the process may include determining whether an initial DL BWP is configured and supports the service received through the number of access modes or not. In an embodiment, the determination may be performed by the UE 102. In an embodiment, where it is determined that the initial DL BWP is configured and supports the service received through the number of access modes, the process may proceed towards step 610. In an embodiment, where it is determined that the initial DL BWP is not configured and the initial DL BWP is not supporting the service received through the number of access modes, the process may proceed towards step 612.

At step 610, the process may include switching, by the UE, from the DL BWP to another BWP indicated by the initial DL BWP in response to determining that the initial DL BWP is configured and supports the service received through the number of access modes. Furthermore, the process may proceed towards step 614. In an embodiment, when the bwp-Inactivitytimer associated with the DL BWP expires and the UE 102 is receiving the multicast and broadcast services on the MBS BWP or frequency resource associated with DL BWP, the UE 102 performs switching to default DL BWP if this is configured for MBS service and continues the multicast and broadcast services reception. In an embodiment, if the initial DL BWP may be configured for the multicast and the broadcast service or supports MBS service, the UE 102 performs BWP switching to the initial DL BWP and continues MBS service reception, else, UE 102 does not perform BWP switching and continues to receive MBS service on the same DL BWP. In case, when UE 102 is not able to pursue MBS service reception on default DL BWP or initial DL BWP or same DL BWP (e.g. MBS service needs high reliability or uplink signaling or retransmissions or reception in The first access mode), UE 102 abandons the at least one of the MBS services or completely abandon the MBS reception. In an embodiment, the UE 102 performs switching to default DL BWP if this is configured, further if the initial DL BWP is configured, the UE 102 performs BWP switching to the initial DL BWP.

According to another embodiment of the present disclosure, a measurement resources or reference signals utilizing common MBS RS and/or DMRS/TRS/SSB/CSIRS are provided over the initial BWP and/or dedicated BWP where broadcast and/or low QoS multicast MBS services are allocated. UEs can perform measurements over these measurement resources. When UE 102 is also receiving broadcast and/or low QoS multicast MBS services in connected mode, UE 102 can also send the measurement report and/or channel feedback e.g. CQI and/or HARQ feedback to the network utilizing uplink channels.

According to another embodiment of the present disclosure, the second access mode multicast and broadcast service for the UE 102 with the first access mode and the second mode such as the low QoS multicast service may be provided utilizing a service specific Discontinuous Reception (DRX) scheduling configurations. In an embodiment it may be implied, that each service or a group of services may include a specific DRX scheduling configuration including drx-onDurationTimerMBS, drxInactivityTimerMBS, drx-LongCycleMBS, drx-SlotOffsetMBS etc. to receive the second access mode MBS services by the UEs. The DRX scheduling configuration for the multicast and the broadcast service or a group of the multicast and the broadcast service may be provided in the broadcasted signalling such as a SIB, MCCH and/or dedicated signalling like RRC reconfiguration message. The services are scheduled with the group common PDCCH addressed with a Group-Radio Network Temporary Identifier (G-RNTI) and allocated over group common Physical Downlink Control Channel (PDSCH) that may be scrambled with the G-RNTI. Further, when a group of service(s) are scheduled with the common G-RNTI and/or common DRX scheduling configuration, they may be multiplexed over same Medium Access Control (MAC) Protocol Data Unit (PDU) or transport block (TB) and are further identified with Logical channel identity (LC_ID). UE 102 not interested to receive one or more of the group of the MBS services being scheduled together or having common DRX scheduling configuration are discarded by the UE 102 at the MAC layer e.g. by identifying the LC_ID and discarding the MAC SDUs pertaining to undesired LC_ID.

At step 612, the process may include receiving the service on the DL BWP. Furthermore, the process may proceed towards step 614.

At step 614, the process may include continuing reception of the service at the UE 102 through the number of access modes.

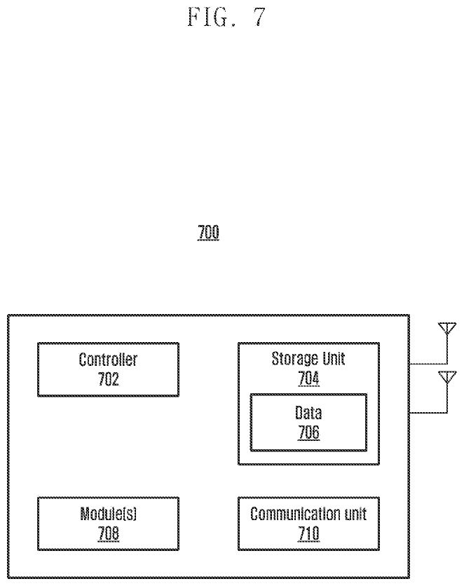

FIG. 7 is a diagram illustrating the configuration of a terminal 700 in a wireless communication system according to an embodiment of the present subject matter. Hereinafter, it is understood that terms including “unit” or “er” at the end may refer to the unit for processing at least one function or operation and may be implemented in hardware, software, or a combination of hardware and software. In an embodiment, the terminal may be similar to the UE 102 as referred n the FIG. 1.

Referring to FIG. 7, the terminal 700 may include a controller 702 (e.g., at least one processor), a storage unit 704 (e.g., storage), data 706 and, module(s) 708, and a communication unit 710 (e.g., communicator or communication interface). By way of example, the terminal 700 may be a User Equipment, such as a cellular phone or other device that communicates over a plurality of cellular networks (such as a 4G, a 5G or pre-5G network or any future wireless communication network). In an embodiment, the controller 702, the storage unit 704, the data 706, and the module(s) 708, and the communication unit 710 may be communicably coupled with one another.

As would be appreciated, the terminal 700, may be understood as one or more of a hardware, a software, a logic-based program, a configurable hardware, and the like. In an example, the controller 702 may be a single processing unit or a number of units, all of which could include multiple computing units. The processor may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the controller 702 may be configured to fetch and/or execute computer-readable instructions and/or data 706 stored in the storage unit 704.

In an example, the storage unit 704 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The storage unit 704 may store data, such as a basic program, an application program, configuration information, and the like for operating the terminal 700. The storage unit 704 may be configured as a volatile memory, a non-volatile memory, or a combination of a volatile memory and a non-volatile memory. The storage unit 704 may include the data 706. In addition, the storage unit 704 may provide data stored therein in response to a request from the controller 702.

The data 706 serves, amongst other things, as a repository for storing data processed, received, and generated by one or more of, the controller 702, the storage unit 704, the module(s) 708, and the communication unit 710.

The module(s) 708, amongst other things, may include routines, programs, objects, components, data structures, etc., which perform particular tasks or implement data types. The module(s) 708 may also be implemented as, signal processor(s), state machine(s), logic circuitries, and/or any other device or component that manipulate signals based on operational instructions.

Further, the module(s) 708 may be implemented in hardware, instructions executed by at least one processing unit, for e.g., controller 702, or by a combination thereof. The processing unit may be a general-purpose processor which executes instructions to cause the general-purpose processor to perform operations or, the processing unit may be dedicated to performing the required functions. In another aspect of the present disclosure, the module(s) 708 may be machine-readable instructions (software) which, when executed by a processor/processing unit, may perform any of the described functionalities.

In some example embodiments, the module(s) 708 may be machine-readable instructions (software) which, when executed by a processor/processing unit, perform any of the described functionalities.

The controller 702 may control overall operations of the terminal 700. For example, the controller 702 may transmit and receive a signal via the communication unit 710. Further, the controller 702 records data in the storage unit 704 and reads the recorded data. The controller 702 may perform the functions of a protocol stack required by a particular communication standard. To this end, the controller 702 may include at least one processor or micro-processor or may be a part of the processor. Also, a part of the communication unit 710 and the controller 702 may be referred to as a communication processor (CP).

Referring to FIG. 1, the communication unit 710 may be configured to receive a first message. In an embodiment, the first message may include a first configuration from the network. In an embodiment, the first configuration may be configured to enables reception of the service at the UE 102 in an access mode amongst the number of access modes. In an embodiment, the first configuration may be one of a RRC configuration, a System Information Block (SIB) and a Multicast Control Channel (MCCH) configuration. Further, first message may be the RRC reconfiguration message for the multicast service and the first message may be the SIB message or MCCH message for the broadcast service.

Furthermore, the communication unit 710 may be configured to receive a second message from the network. In an embodiment, the second message may include one or more of the first configuration and at least one other configuration. In an embodiment, the one or more of the first configuration and the at least one other configuration may be configured to enable the reception of the service at the UE 102 in the other access mode. In an embodiment, the at least one other configuration may be one of a RRC release configuration and a RRC release with suspend configuration, a RRC connection establishment configuration, and a RRC connection resumption configuration. In an embodiment, the controller 702 may be configured to access the service in the other access mode through the one or more of the first configuration and the at least one other configuration.

Referring to FIG. 2a, the communication unit 710 may be configured to transmit a multicast join request to the network. In an embodiment, the multicast join request may indicate that the UE 102 is trying to receive the multicast service through the number of access modes.

Furthermore, the communication unit 710 may be configured to receive a first message from the network. In an embodiment, the first message may include a first configuration enabling reception of the multicast service at the UE 102. In an embodiment, the first configuration may be a RRC configuration. In an embodiment, upon receiving the first configuration, the controller 702 may initiate receiving the service through the first access mode by default.

Moving ahead, the communication unit 710 may be configured to receive from a network a second message. In an embodiment, the network may transmit the second message in response to determining a requirement to switch the number of access modes amongst one another. In an embodiment, the second message may include one or more of the first configuration and at least one other configuration in response to determining the requirement. In an embodiment, the one or more of the first configuration and the at least one other configuration may be configured to enable the reception of the multicast service at the UE 102 in a second access mode. In an embodiment, the at least one other configuration may be one of a RRC release configuration and a RRC release with suspend configuration. In an embodiment, the RRC release configuration may be configured to release the UE 102 from the first access mode and enable the reception of the multicast service through the second access mode in an Idle mode. Furthermore, the RRC release with suspend configuration may be configured to release the UE 102 from the first access mode and enable the reception of the multicast service through the second access mode in an Inactive mode.

In an embodiment, where it is determined that the UE 102 through the communication unit 710 is receiving the multicast service through the second access mode over the specific service BWP or the CFR including a scenario when the multicast service BWP or the CFR may be confined within the initial BWP or may be mapped over the initial BWP and/or an extended over BWP or the CFR that comprises the initial BWP within itself, the process the controller 702 may be configured to switch the UE 102 from a specific service BWP or a CFR to the initial BWP based one of abandoning by the UE 102 the reception of the service and changing by the one of a cell and an area providing the multicast service. In an embodiment, the controller 702 may be configured to establish a RRC connection and receiving the multicast service in a PTP (Point to point) delivery mode or a unicast mode on the dedicated BWP in response to determining that the multicast service is abandoned by the network.

Referring to FIG. 2b, the communication unit 710 may be configured receive from the network, the second message. In an embodiment, the second message may include one or more of the first configuration and the at least one other configuration. In an embodiment, the at least one other configuration may be one of the RRC release configuration and the RRC release with suspend configuration for the high QoS multicast service. In an embodiment, the RRC release configuration may be configured to release the UE 102 from the first access mode and enable the reception of the multicast service through the second access mode in an Idle mode. Furthermore, the RRC release with suspend configuration may be configured to release the UE 102 from the first access mode and enable the reception of the multicast service through the second access mode in an Inactive mode.

Referring to FIG. 2c the communication unit 710 may be configured to receive the second message from the network. In an embodiment, the second message may include the one or more of the first configuration and the at least one other configuration. In an embodiment, the at least one other configuration may be one of the RRC release configuration and the RRC release with suspend configuration for modifying the configuration of the multicast service. In an embodiment, the RRC release configuration may be configured to release the UE 102 from the first access mode and enable the reception of the multicast service through the second access mode. Furthermore, the RRC release with suspend configuration may be configured to release the UE 102 from the first access mode and enable the reception of the multicast service through the second access mode in an Inactive mode.

Referring to FIG. 3a, the communication unit 710 may be configured to receive the second message from the network. In an embodiment, the controller 702 may be configured to access the multicast service or the broadcast service in the second access mode through the at least one other configuration upon receiving the second message.

Referring to FIG. 3b, the communication unit 710 may be configured to receive the second message from the network. In an embodiment, the controller 702 may be configured to access the multicast service or the broadcast service in the first access mode through the at least one other configuration upon receiving the second message.

Referring to FIG. 4, the communication unit 710 may be configured to transmit one of a RRC connection establishment request and a RRC connection resumption request to the network. In an embodiment, the one of a RRC connection establishment request and a RRC connection resumption request may be transmitted for switching to the first access mode from the second access mode for receiving the multicast service or the broadcast service. Moving forward, the communication unit 710 may be configured to receive one of a RRC connection establishment failure response and a RRC connection resumption failure response from the network upon determining by the network presence of the congestion at the network.

Referring to FIG. 5, the controller 702 may be configured to attempt switch to the first access mode from the second access mode. In an embodiment, the switching may be attempted by the communication unit 710 by sending one of a RRC connection establishment request and a RRC connection resumption request to the network to switch to the first access mode. In an embodiment, the controller 702 may be configured to determine presence of the congestion at the network. In an embodiment, the controller 702 may be configured to determine whether the congestion is present or not at the network based on receiving an indication from the network. In an embodiment, the indication may determine whether the congestion is occurring at the network or not upon sending one of the RRC connection establishment request and the RRC connection resumption request.

Further, the controller 702 may be configured to start a timer configured for a pre-determined amount of time and attempting to switch to the first access mode after completion of the timer in response to determining presence of the congestion at the network. In an embodiment, the controller 702 may be configured to transition to the first access mode in response to determining an absence of the congestion.

Referring to FIG. 6, the controller 702 may be configured to detect an expiry of a bwp-inactivitytimer associated with an active Downlink BWP (DL BWP). Further, the controller 702 may be configured to determine whether a default DL BWP is configured and supports the service received through the number of access modes in response to expiration of the bwp-inactivitytimer associated with the DL BWP in an active state.

Continuing with the above embodiment, the controller 702 may be configured to switch from the DL BWP to another BWP indicated by the default DL BWP. Moving forward, the controller 702 may be configured to determine whether an initial DL BWP is configured and supports the service received through the number of access modes or not.

Further, the controller 702 may be configured to switch the UE 102 the DL BWP to another BWP indicated by the initial DL BWP in response to determining that the initial DL BWP is configured and supports the service received through the number of access modes.

Moving forward, the communication unit 710 may be configured to receive the service on the DL BWP and reception of the service at the UE 102 through the number of access modes.

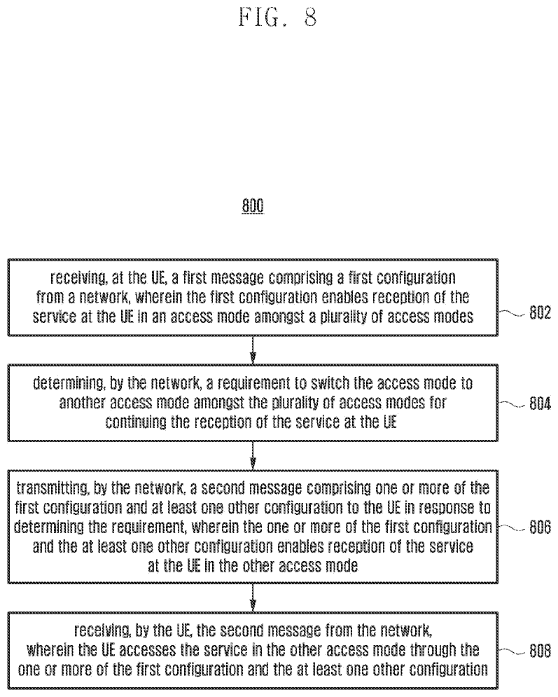

FIG. 8 illustrates a schematic block diagram 800 depicting a method for reception of a service in NR at a UE, in accordance with an embodiment of the present subject matter. The method 800 may be implemented by the terminal 700 using components thereof, as described above. In an embodiment, the method 800 may be executed by the controller 702, and the communication unit 702. Further, for the sake of brevity, details of the present disclosure that are explained in details in the description of FIG. 1 to FIG. 7 are not explained in detail in the description of FIG. 8.

At block 802, the method includes receiving, at the UE, a first message comprising a first configuration from a network, wherein the first configuration enables reception of the service at the UE in an access mode amongst a plurality of access modes.

At block 804, the method includes determining, by the network, a requirement to switch the access mode to another access mode amongst the plurality of access modes for continuing the reception of the service at the UE.

At block 806, the method includes, transmitting, by the network, a second message comprising one or more of the first configuration and at least one other configuration to the UE in response to determining the requirement, wherein the one or more of the first configuration and the at least one other configuration enables reception of the service at the UE in the other access mode.

At block 808, the method includes receiving, by the UE, the second message from the network, wherein the UE accesses the service in the other access mode through the one or more of the first configuration and the at least one other configuration.

While specific language has been used to describe the present disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for reception of a service in New Radio (NR) at a User Equipment (UE), the method comprising:
receiving, at the UE, a first message comprising a first configuration from a network, wherein the first configuration enables reception of the service at the UE in an access mode amongst a plurality of access modes;
determining, by the network, a requirement to switch the access mode to another access mode amongst the plurality of access modes for continuing the reception of the service at the UE;
transmitting, by the network, a second message comprising one or more of the first configuration and at least one other configuration to the UE in response to determining the requirement, wherein the one or more of the first configuration and the at least one other configuration enables reception of the service at the UE in the other access mode; and
receiving, by the UE, the second message from the network, wherein the UE accesses the service in the other access mode through the one or more of the first configuration and the at least one other configuration.

2. The method as claimed in claim 1, wherein the service is one of a broadcast service and a multicast service, further wherein the multicast service is one of a high Quality of Service (QoS) multicast service and a low QoS multicast service.

3. The method as claimed in claim 1, wherein the access mode and the other access mode is one of a first access mode and a second access mode, further wherein the first access mode is a Connected mode and the second access mode is one of an Idle mode and an Inactive mode for receiving the service.

4. The method as claimed in claim 1, wherein the requirement to switch to the other access mode is determined upon detecting occurrence of an event associated with the access mode, wherein the event is one of a congestion at the network, a change in a QoS associated with the service, presence of a new service to be provided to the UE in a Connected mode.

5. The method as claimed in claim 1, wherein the first configuration is one of a RRC configuration, a System Information Block (SIB) configuration, /and a Multicast Control Channel (MCCH) configuration and at least one other configuration is one of a RRC release configuration and a RRC release with suspend configuration, a RRC connection establishment configuration, and a RRC connection resumption configuration, and
wherein the RRC release configuration releases the UE from the access mode and enables reception of the service in the other access mode in the Idle mode and the RRC release with suspend configuration releases the UE from the access mode and enables reception of the service in the other access mode in the Inactive mode.

6. The method as claimed in claim 1, wherein the first message is the RRC reconfiguration message for the multicast service and the first message is the SIB message or MCCH message for the broadcast service.

7. The method as claimed in claim 1, wherein the second message comprises the first configuration and the at least one other configuration for the multicast service and the at least one other configuration for the broadcast service.

8. The method as claimed in claim 1, wherein the second message comprises one of the RRC connection establishment message, and the RRC connection resumption message to switch the reception of one of the multicast service and the broadcast service at the UE through the second access mode to the first access mode.

9. The method as claimed in claim 1, wherein the first access mode is switched to the second access mode for replacing the high QoS multicast service with the low QoS multicast service.

10. The method as claimed in claim 1, wherein the service is accessed through the second access mode over one of:
an initial Bandwidth Part (BWP) comprising an allocation for a service BWP or a Common Frequency Resource (CFR) for the UE receiving the service through one of the first access mode and the second access mode, wherein the service allocation overlaps with another allocation associated with a dedicated unicast BWP or the CFR to support the UE receiving one of the broadcast service and the multicast service through the first access mode;
an initial BWP and a dedicated BWP;
a default BWP configured for service reception; and
a specific service BWP or a CFR, and
wherein the UE is receiving the service through the second access mode over the specific service BWP or the CFR, further comprises:
performing, by the UE, one of:
switching from the specific service BWP or the CFR to the initial BWP based on occurrence of one of:
abandoning, by the UE, the reception of the service;
changing, by the UE, one of a cell and an area providing the service; and
establishing a RRC connection and receiving the service in a unicast mode on the dedicated unicast BWP in response to determining that the service is abandoned by the network.

11. The method as claimed in claim 1, further comprises:
transmitting, by the UE, one of a RRC connection establishment request and a RRC connection resumption request to the network for switching to the first access mode from the second access mode; and
receiving by the UE, one of a RRC connection establishment failure response and a RRC connection resumption failure response from the network upon determining by the network presence of the congestion at the network.

12. The method as claimed in claim 1, wherein the UE is receiving the multicast service through the second access mode, further comprises:
attempting, by the UE, to switch to the first access mode by sending one of a RRC connection establishment request and a RRC connection resumption request to the network to switch to the first access mode, wherein the UE determines presence of the congestion at the network; and
performing, by the UE, one of:
starting, by the UE, a timer configured for a pre-determined amount of time and attempting to switch to the first access mode after completion of the timer in response to determining presence of the congestion at the network; and
transitioning to the first access mode in response to determining an absence of the congestion at the UE, and
wherein the UE determines whether the congestion is present or not at the network based on receiving an indication from the network determining whether the congestion is occurring at the network or not upon sending one of the RRC connection establishment request and the RRC connection resumption request.

13. The method as claimed in claim 1, wherein the UE is receiving in the first access mode further comprises:
determining, by the UE, that a default DL BWP is configured and supports the service received through the plurality of access modes in response to expiration of a timer associated with a DL BWP in an active state;
switching, by the UE, from the DL BWP to another BWP indicated by the default DL BWP.

14. The method as claimed in claim 1, further comprises:
determining, by the UE, that a default DL BWP is not configured and the default DL BWP is not supporting the service received through the plurality of access modes in response to expiration of a timer associated with a DL BWP in an active state;
determining, by the UE, whether an initial DL BWP is configured and supports the service received through the plurality of access modes or not;
performing, by the UE, one of:
switching, by the UE, from the DL BWP to another BWP indicated by the initial DL BWP in response to determining that the initial DL BWP is configured and supports the service received through the plurality of access modes; and
receiving the service on the DL BWP, and
wherein the UE receives the first message comprising the first configuration from the network enabling reception of the multicast service at the UE in response to transmitting a multicast join request to the network.

15. A system for reception of a service in New Radio (NR) at a User Equipment (UE), the system comprising:
receiving, at a communication unit (710), a first message comprising a first configuration from a network, wherein the first configuration enables reception of the service at the UE in an access mode amongst a plurality of access modes;
determining, by the network, a requirement to switch the access mode to another access mode amongst the plurality of access modes for continuing the reception of the service at the UE;
transmitting, by the network, a second message comprising one or more of the first configuration and at least one other configuration to the UE in response to determining the requirement, wherein the one or more of the first configuration and the at least one other configuration enables reception of the service at the UE in the other access mode; and
receiving, at the communication unit (710), the second message from the network, wherein the UE accesses the service in the other access mode through the one or more of the first configuration and the at least one other configuration.
